(19) United States
(12) Patent Application Publication
(10) Pub. No.: US 2025/0269354 A1
(43) Pub. Date: Aug. 28, 2025

(54) Ethylene oxide scrubbing sheet

(71) Applicant: Richard P. WARBURTON, Pittsburgh, PA (US)

(72) Inventors: Piers Richard Warburton, Sewickley, PA (US); Aaron P DeLeo, Verona, PA (US)

(73) Assignee: ChemDAQ Inc., Pittsburgh, PA (US)

(21) Appl. No.: 17/638,291

(22) PCT Filed: Sep. 11, 2020
(86) PCT No.: PCT/US2020/050462

§ 371 Date: Dec. 15, 2022

Related U.S. Application Data
(60) Provisional application No. 62/899,838, filed on Sep. 13, 2019.

(51) Int. Cl. B01J 20/28; B01D 53/04; B01D 53/72; B01D 53/82; B01J 20/32

(52) U.S. Cl. CPC B01J 20/28035; B01D 53/0407; B01D 53/72; B01D 53/82; B01J 20/321; B01D 2251/70; B01D 2251/80; B01D 2253/25; B01D 2257/708; B01D 2258/06

(57) ABSTRACT

An ethylene oxide (EtO) scrubbing sheet for the removing fugitive EtO emissions from, for example, sterilized medical devices and leaks from chemical plants. The scrubbing sheet comprises an acid impregnated layer, a second layer impregnated with an acid neutralizer, combined inside a gas porous protective membrane. The EtO enters the sheet by diffusion and is removed by irreversible chemical reaction.

### PRIORITY

This application claims priority from provisional application Ser. No. 62/899,838, filed on Sep. 13, 2019 and from application number PCT/US2020/050462 filed under the Patent Cooperation Treaty on Sep. 11, 2020.

### BACKGROUND

Ethylene oxide (EtO) is a reactive gas that has been used since the 1950s to sterilize medical devices. According to the Ethylene Oxide Sterilization Association (EOSA), over 50% of medical devices are sterilized with EtO today [https://www.eosa.org/sites/default/files/2018-08/The%20Benefits%20of%20Ethylene%200xide%20Sterilization.pdf, accessed Aug. 27, 2020]. EtO has several key advantages over competing sterilization technologies. These include 1) excellent chemical compatibility, 2) no damage to medical devices, and 3) excellent penetrating ability so medical devices can be sterilized by the pallet rather than individually or in small packages and 4) relatively low cost.

The excellent penetrating ability of EtO means that it can readily penetrate packaging and even diffuse through some plastics, but it also means that the EtO is slow to diffuse out of the medical devices and their packaging post-sterilization. This off-gassing is typically an approximate exponential decay with a half-life of hours and the rate of off-gassing depends on many factors including temperature, packaging, materials used, and how the packages are assembled. It also means that there is no sharp endpoint for the off-gassing. Medical device manufacturers (MDMs) and contract sterilization companies (CSCs) use their best judgment as to when the outgassing is sufficiently complete, to allow the product to be shipped to the end user, or more commonly to a warehouse for later distribution. If they delay too long, then the supply chain is unnecessarily held up and if they ship too soon, there is a risk that the medical devices will continue to off-gas significant amounts of EtO during transportation.

Medical devices are typically shipped by the pallet in truck trailers via land, and by shipping containers for international transportation. If the pallet, trailer or container is sealed, then the off-gassed EtO can build up inside. Even a low rate of EtO off-gassing can create a significant concentration of EtO if the enclosure is airtight and with no ventilation. The build-up of EtO presents a hazard to personnel at the destination where container is opened either for customs inspection or to remove the pallets from the trailer or container.

Ethylene oxide has been determined to be a known human carcinogen by the International Agency for Research on Cancer (IARC) [IARC monograph 97 (2018), available from https://monographs.iarc.fr/wp-content/uploads/2018/06/mono97-7. pdf], by the US National Toxicology Program [NTP Report on Carcinogens, Fourteenth Edition, 2016, Ethylene Oxide, available from https://ntp.niehs.nih.gov/ntp/roc/content/profiles/ethyleneoxide.pdf] and the US Environmental Protection Agency [Evaluation of the Inhalation Carcinogenicity of Ethylene Oxide (CAS Reg. No. 75-21-8). In Support of Summary Information on the Integrated Risk Information System (IRIS), December 2016, available from https://cfpub.epa.gov/ncea/iris/iris_documents/documents/toxreviews/1025tr.pdf]. To prevent occupational exposure to EtO, most organizations that receive shipments of recently EtO sterilized equipment will use continuous monitors to ensure the EtO concentration is below occupational exposure limits. In the United States the permissible exposure limits are promulgated by the Occupational Safety and Health Administration (Ethylene Oxide Standard 2 9CFR 1910.1047). Portable and fixed monitors used to measure EtO concentrations to prevent occupational exposure are well known in the prior art, for example the EtO Steri-Trac® and SafeCide™ monitors from ChemDAQ Inc. (Pittsburgh, PA).

Because more than 20 billion medical devices are sterilized by EtO each year in the US alone (EOSA), and many more in other countries, EtO exposure from off-gassing medical devices is a well-known problem which has been documented many times in the prior art. See for example:
1. Health risks in international container and bulk cargo transport due to volatile toxic compounds, Xaver Baur, Lygia Therese Budnik, Zhiwei Zhao, Magne Bratveit, Rune Djurhuus, Louis Verschoor, Federico Maria Rubino, Claudio Colosio, and JorgenR Jepsen J Occup Med Toxicol. 2015; 10:19.,
2. Accidental exposure to gas emissions from transit goods treated for pest control, Stefan Kloth, Xaver Baur, Thomas Goen, and Lygia Therese Budnik, Environ Health. 2014; 13:110.
3. Hazard Surveillance: Residual Chemicals In Shipping Containers, SafeWork Australia, December 2012, https://www.safeworkaustralia.gov.au/system/files/documents/1702/hazard-surveillance-residual-chemicals-shipping-containers.pdf
4. Surprises perilous: Toxic health hazards for employees unloading fumigated shipping containers, Science of The Total Environment 409 (17): 3106-13 Aug. 2011,
5. High frequency of fumigants and other toxic gases in imported freight containers—an underestimated occupational and community health risk. Xaver Baur, Bernd Poschadel and Lygia Therese Budnik, Occupational and Environmental Medicine, Vol. 67, No. 3 (March 2010), pp. 207-212https://www.jstor.org/stable/27797732?seq=1#page_scan_tab_contents

The primary measures to minimize or eliminate the EtO off-gassing problem are:
1) Allow the product to aerate longer before shipping-longer aeration adds delay and hence cost to the supply chain.
2) Adding ventilation to truck trailers and shipping containers-not always practical since many trailers and shipping containers are owned by third parties and are general purpose. Shipping containers in particular are designed to be airtight to protect their contents during transportation.
3) Allowing trailers and containers to aerate after opening but before unloading/inspection—delays unloading process, decreases efficiency.
4) Packing the pallets so that there are aeration channels between boxes in the pallet to facilitate escape of EtO-EtO escapes into surrounding volume.

All of these measures have been applied, with limited success and additional cost, however measures 2-4 also do not reduce fugitive emissions of EtO into the atmosphere.

People at facilities receiving EtO sterilized medical devices are being exposed to excessive concentrations of EtO upon opening trailers and shipping containers, unloading the pallets and breaking them down (unpacking). A simple means is needed that will remove EtO during transit. In addition, medical devices may continue to off-gas EtO in the warehouse and cumulatively the off-gassings may result in a significant amount of EtO being released into the air. While the air can be exhausted to the outside, treating air is expensive and the EtO off-gassing contributes to the fugitive emissions. A simple means is needed to remove EtO from the air near stored medical devices.

Sterilization facilities that use EtO remove it from the air stream leaving the sterilizer or aeration rooms to prevent it from escaping into the atmosphere, and thus exceed the strict maximum EtO emission limits that they must abide to under their operating permits. There are several technologies used to remove EtO from air streams, but the most common is a sulfuric acid scrubber. The EtO containing air passes through a scrubber such that the air intimately contacts an aqueous solution of sulfuric acid, which absorbs the EtO and hydrolyzes it to ethylene glycol.

H₂SO₄

H2COCH2+H2O=>HOCH2CH2OH

This technology removes EtO well, but it is not practical to place a sulfuric acid scrubber inside a pallet of medical devices because a spill of acid would result in damage to the medical devices and present a challenge to clean-up that most warehouses are not equipped to handle. Even if the acid is restrained within a container, there is a risk that the trailer may be involved in an accident, potentially rupturing the sulfuric acid container. If the acid were escape in transit, it would pose a greater risk to personnel unloading the trailer or container than the EtO the acid was supposed to remove.

Another technology commonly used to remove EtO employs strong acid ion exchange resins in which sulfonate moieties are chemically bound to a polystyrene polymer backbone. These ion exchange resins are very effective in reducing small amounts of EtO in an air stream to lower EtO concentrations. An example of ion exchange resins being used to remove EtO is described in U.S. Pat. No. 4,165,440A. Ion exchange resins tend to be expensive and are usually comprised of small beads that are difficult to clean-up in case of a spill. Other EtO removing air scrubbers have been made from zeolites in the acid form, e.g. U.S. Pat. No. 20,040,231511A1. Hospitals use devices known as abators to remove EtO from waste streams from EtO sterilizers. The most common design is from 3M (Minneapolis, MN, [https://multimedia.3m.com/mws/media/6307600/eo-abator-model-50-system-brochure.pdf]) and it operates by passing the air stream over a heated catalyst, which catalytically oxidizes EtO to carbon dioxide and water. This system works well but it is large, heavy and requires a power supply to operate and so is unsuitable for use to remove EtO from truck trailers, pallets or shipping containers.

EtO is the precursor chemical to many items including ethylene glycol (used in antifreeze), surfactants and thickeners in shampoos, pharmaceuticals etc. EtO is one of the largest volume chemicals manufactured in the world and according to the American Chemistry Council, EtO production involves more than 45,000 jobs and adds about $3.5 billion in direct value into the US economy. However, EtO loss through fugitive emissions from pumps, valves, and other pressurized connections is a major issue for manufacturers, who like the medical device sterilization companies are under increasing pressure from the US Environmental Protection Agency (EPA) [EPA Moves Forward on Suite of Actions to Address Ethylene Oxide, EPA News Release, Nov. 6, 2019, https://www.epa.gov/newsreleases/epa-moves-forward-suite-actions-address-ethylene-oxide] and state agencies. The EPA estimated that 23 tonnes of ethylene oxide were released into the air from US chemical manufacturers in 2017. [Is it time to crack down on ethylene oxide emissions? Chemical makers push back on possible tighter controls of carcinogen in the US, by Cheryl Hogue, Chemical and Engineering News Sep. 28, 2019 vol 97, no.38]. At present the primary means for control of these fugitive emissions is to periodically inspect each potential leak point, and correct those with leak.

What is needed is a means to remove any EtO that off-gasses during shipment and prevent the build-up of EtO. These devices should be small enough that they can be placed near, on, or within a pallet, not occupy much volume and minimally add to the weight. In addition, electrical power is not available in most trailers and shipping containers, so the means for removal of EtO should operate without electrical power or be designed to use low enough power so that small batteries can be used for power.

In addition, a device is needed that can be placed around valves, pipe connections etc. in chemical plants and other places EtO is used and where EtO fugitive emissions may occur so that these emissions are removed before they are reach the atmosphere.

For example, EtO off-gassing is also a problem in other industries that use EtO as a fumigant, for example museum and library archives. [Preservation Research and Testing Series No. 9502, Desorption of Residual Ethylene Oxide from Fumigated Library Materials, Frank H. Hengemihle, Norman Weberg and Chandru Shahani, Preservation Research and Testing Office, Preservation Directorate, Library of Congress, Washington, D.C., November 1995, available from https://www.loc.gov/preservation/resources/rt/fume.pdf, accessed Sep. 13, 2019]. Since EtO is recognized by the EPA and other organizations, it is important that these emissions be reduced as well.

### SUMMARY OF THE INVENTION

An EtO scrubbing device which passively scrubs EtO, removing it from the air by an irreversible chemical reaction so that the EtO cannot be released again. This device can be made small enough to fit between the boxes or packages of medical devices and products comprising a pallet, or it can be large enough to be wrapped around pallets, valves or other sources of fugitive EtO emissions. This device will also be useful to reduce EtO emissions in any application where EtO is used. While the basic version is passive, if this technology is combined with a fan or other air flow device, the present invention can be used to scrub air within a trailer (e.g. using a battery or DC voltage from the truck for power), shipping container or other enclosed space.

### FIGURES

FIG. 1 shows an EtO removing sheet from top view

FIG. 2 shows side view cut to reveal internal structure

FIG. 3 shows side view cut to reveal internal structure of an alternative embodiment

FIG. 4 shows side view cut to reveal internal structure of another embodiment

FIG. 5 shows a scrubber sheet for use with a fan

### DETAILED DESCRIPTION OF THE INVENTION

Occupational exposure from continued EtO off-gassing is a recognized problem for medical device manufacturers and in other industries. The current solutions of increased ventilation during transportation and long aeration times add delay to the supply chain. In addition, there is concern about the release of EtO into the environment, and many facilities that manufacture or use EtO have taken measures to reduce their emissions to the point that now fugitive emissions have become a significant fraction of their total emissions. What is needed is a small lightweight, low-cost device that removes EtO efficiently with no external power, and preferably in a slim format that can be placed on, around or between pallets, valves, pipe junctions, etc. The present invention, an EtO scrubber sheet, meets these criteria. The simplest configuration is a flat sheet, and the invention is herein described primarily as a sheet, but other configurations such as rods or cylinders may be preferred depending on the application; and are included within the scope of the present invention. Similarly, the present invention can readily be implemented to custom shapes, to, for example, blanket a large valve in a chemical plant, in a similar manner to the thermal blankets currently used in the chemical industry to protect valves, etc. from low temperatures. Indeed, the current invention could be combined with a thermal blanket to both protect the valve or other device from the elements and to control EtO emissions.

Medical device shipments typically consist of medical devices packed in cardboard boxes, with the boxes stacked on a pallet. A standard pallet is 4 ft×4 ft, but other sizes are also used, and the boxes may be stacked four to six feet tall. One of the ways to help the EtO escape from a pallet during aeration is to pack the boxes such that there are channels leading to the outside of the pallet, thus venting the pallet. It may be desirable to place the EtO scrubber sheet between the boxes of medical devices within the pallet, or it may be better to place a cylinder of the EtO scrubber within the channel. The EtO scrubbing sheets must be placed in the pallet post-sterilization, so any channels must be positioned to allow easy access. Whatever the physical configuration, there is a common set of demands that the invention must meet.

The requirements for a device providing this solution are:
Rapid and effective removal of ETO gas.
Low cost.
Light weight (minimise extra weight to shipment).
Small volume (minimise extra volume to shipment).
Easy and safe to handle, i.e. easy to pick up and place by hand (small beads for example would be an impediment), without special training or equipment.
Not fragile, nothing to break, for example if dropped or flexed.
Preferably flexible/bendable-can be folded if needed, but should be firm enough that it can pushed between boxes if needed.
No hazardous liquid chemicals inside that could spill or leak.
Non-hazardous to skin or eyes if contacted.
No hazardous vapors prior to and subsequent to exposure to EtO.
Non-hazardous waste, (disposed of in regular trash). Therefore, no heavy or toxic metals, no toxic compounds that can be leached out of it by water.
Device should permanently remove the EtO, not just absorb it such that EtO can later desorb as with activated carbon.

The device should incorporate a chemistry that irreversibly reacts with EtO so that the EtO is permanently removed from the air. Several compositions which remove EtO are discussed below that have been shown to be effective. Other chemistries that effectively irreversibly removes EtO from the air could also be incorporated into the present invention.

As discussed above, sulfuric acid hydrolyses EtO efficiently, but sulfuric acid is impractical to use for the reasons discussed earlier. A solid acid would not have these limitations. For purposes of this application, a solid acid is an acid with which occurs as a solid under normal use conditions (typically temperature −20° C. to +40° C., non-condensing humidity and dew point <20° C.), i.e. it does not flow to a significant extent over usage time (months).

Examples of solid acids are oxalic acid. Testing with oxalic acid (pKₐ_{¹}=1.23, pKₐ_{²}=4.19) showed that it successfully removed EtO. Similar results were obtained with maleic acid (pKₐ 1.9 & 6.07). Weaker acids (higher pKₐs) removed some EtO, but were less efficient. Improved results were obtained with solid acids that were also strong acids. For purposes of this application a strong acid is an acid with a pKa of less than or equal to 1, such as solid sulfonic acid. p-toluenesulfonic acid (p-TSA) from Sigma Aldrich is a solid strong acid (MP=104° C.) that was found to remove most or all of the EtO. Naphthalene-2-sulfonic acid from Alfa Aesar, and poly (styrene sulfonic acid) from both Alpha Aesar and Sigma Aldrich produced similar results to p-TSA.

Conventional strong acids, such as sulfuric acid can also be used, if they can be fixed as a solid. For example, there is a well-established technology for solidifying sulfuric acid for use in lead acid batteries using silica gel in the prior art and providing the formulation does not allow any of the liquid acid to egress, then it too can be used within the scope of this invention. However, unlike a gel battery, the acid in the present invention must be exposed to the air. It is difficult to ensure the sulfuric acid in the solidified sulfuric acid does not migrate over time without additional design constraints and so while it will remove EtO, it is not a preferred embodiment.

Strong solid acids are capable of removing EtO effectively, and since they are solid, they do not leak. Without intending to provide any limitation of the scope of this application, the inventors believe that the reaction between the EtO and the p-TSA is a hydrolysis reaction similar to the reaction of EtO_with sulfuric acid forming either ethylene glycol if water is present or polyethylene glycol under low water/humidity conditions. In testing, the EtO sheet with p-TSA removed EtO from dry tests gas from a compressed gas cylinder with no added water, indicating that the process occurs without added humidity. Therefore, the preferred strong acid for the present invention is p-TSA, polysulfonic acid and naphthalene 2-sulfonic acid, though p-TSA is the most preferred strong acid.

If the solid acid is deposited on a high surface area inert support, then removal of EtO is more efficient. Ideally, the inert support should include the following properties:
A thin high surface areas flexible sheet, in planar form factor or other geometry needed for the application.
Mechanical integrity—able to be folded, dropped, and otherwise manipulated without breakage
Non-hazardous to simplify manufacture of EtO scrubbing sheets and non-hazardous for final disposal
The support needs to be inert to strong acids, and indefinitely stable
Hydrophilic surface for easy deposition of the acid
Low cost
Mechanically flexible for easy manufacture of the EtO scrubbing sheets

There are many potential inert supports, including non-woven polypropylene, non-woven polyethylene, fiber glass, glass fiber paper, and silica impregnated polyethylene, but the preferred support is non-woven polypropylene (PP) sheet treated with surfactants to make it hydrophilic. Non-woven PP sheets are well known in the prior art and find many applications such general-purpose absorbents for treating chemical spills. Depending on the application another preferred support is Teslin, a synthetic paper from PPG Industries Inc. (Pittsburgh PA) comprised of a polyethylene/silica powder mixture. The Teslin paper is hydrophilic and can be written on with water-based inks, but the material itself is strong, flexible and chemically inert. This material is widely used for identification badges, passports etc. Both of these supports can be impregnated with p-TSA by dissolving the p-TSA in water and absorbing the resulting solution into the support and allowing the support to air dry. There are many other materials that in light of this disclosure could be used for support material in the EtO scrubber.

A screening test was employed to check the efficacy of these EtO scrubbing sheets. The same mass of the acid dissolved in water was deposited on a high surface area hydrophilic sheet of non-woven polypropylene and air dried. The sheet was placed in a chamber of approximately 4.5 liters volume, along with a sensor for EtO that provided a continuous reading, ˜1 measurement/second, with a resolution of 0.1 ppm (EtO E-cell® sensor, ChemDAQ Inc., Pittsburgh PA). The EtO concentration was monitored over time. 5 ppm EtO/nitrogen gas was passed into the chamber at 1 lpm for 10 minutes, and then the chamber was sealed for 10 minutes. The EtO concentration after 5 and 10 minutes with EtO being supplied to the chamber and 10 minutes after the EtO was turned off and the chamber closed, was recorded to provide a measure of the effectiveness of the EtO scrubbing sheet.

### Example 1

Preparation: A Solution of 1 g of p-TSA in 80 ml of water was prepared and soaked into a 17″×19″ non-woven polypropylene sheet. The sheet was wrung out by hand and the expelled water reabsorbed several times to spread the liquid evenly throughout the sheet. The sheet was placed on a rack and allowed to air dry overnight.

Testing: The sheet was placed into a sealed container, approximately 5L volume with an EtO sensor (ChemDAQ EtO E-cell® with Bluetooth connection to a tablet computer, running ChemDAQ SafeCide software). EtO gas (˜5 ppm/N₂ balance) was passed into the container at 1 lpm for 10 minutes and then turned off and the readings from the sensor were recorded over ten minutes. With no EtO scrubbing sheet, or a blank sheet with no acid, the EtO readings went to ˜5 ppm and stayed there once the gas was turned off, but with the above p-TSA impregnated sheet, the readings went to about 1 ppm with the gas flowing and then dropped to zero with the gas off after ten minutes.

### Example 2

A solution of 1 g of p-TSA was dissolved in water (24 ml) and a sheet of 8.5×11″ of Teslin was dipped in the solution and allowed to soak for a few minutes. The sheet was removed from the solution and was placed on a rack to air dry. The sheet was tested as in Example 1. The reading 10 min after the EtO gas was turned off was 0.2 ppm indicating that the sheet had removed almost all of the EtO.

Experimentation has shown that the p-TSA on a solid support works well, but there is a risk in use that if the support became wet, the acid could leach out and contact people's hands causing injury or damage to property.

In addition, materials with a net pH of less than 3 cannot be disposed in the regular trash and these sheets with the solid strong acids, if wetted, have a pH close to 1. However, the acid can be rendered safe by neutralization. The preferred acid neutralizer should be safe in both the acid and basic forms for contact to skin. Compounds known to neutralize strong acids and are safe for common usage, include carbonates (sodium, calcium, magnesium), bicarbonate (e.g. sodium), borate (e.g. sodium) and the salts of weak acids. The preferred reagents should have the following properties:
Safe for skin contact and ingestion
Non-hazardous to the environment
Low cost

The acid neutralizer is preferably water-soluble so that it is easy to impregnate into porous materials using a similar method to that used to deposit the solid acid in Example 1. The preferred reagents are sodium citrate (i.e. trisodium citrate), sodium carbonate, sodium bicarbonate and sodium borate, with the sodium citrate being the most preferred, but many other chemicals known in the chemical arts that meet the above requirements can be substituted within the scope of this invention.

The sodium citrate is impregnated onto a porous hydrophilic sheet using the method as for the solid acid in Example 1. The amount of citrate present should exceed that needed to neutralize all the p-TSA or other acid used, so that if the EtO scrubbing sheet becomes wet, all the acid will be neutralized and rendered safe.

On the outside of the EtO scrubber there is an outer gas-porous material which provides mechanical protection for the EtO scrubber and prevents direct contact of the acid and reagent layers by users. This outer material is preferably hydrophobic to protect the EtO scrubber from water ingress. Suitable examples are porous polytetrafluoroethylene membrane, and non-woven polyolefins such as Dupont's Tyvek® (non-woven polyethylene). The latter is preferred because of cost.

In most applications, both sides of the EtO scrubbing sheet will be porous to EtO gas, to maximize the rate of removal of EtO gas. Depending on the application, it may be desirable to have only one surface of the EtO scrubbing sheet porous to gas, and the other sheet impermeable. For example, if the EtO scrubbing sheet is being used to reduce fugitive emissions from an outside valve, then the porous inner layer should be wrapped around the valve, so that any fugitive EtO emissions can diffuse into the sheet and be chemically removed. The outer layer should be impermeable to EtO, so that any EtO in the sheet does not escape, but has longer contact time with the solid acid, and the outer side should also be impermeable to the rain, hail and other elements of the weather.

In some applications, such as short haul truck trailers it is beneficial to reduce the EtO concentration as much as possible. In this situation, an active EtO scrubber provides a better solution than the passive scrubbers described above. The active scrubber uses the same chemistry—a strong acid on a gas porous support, but instead of the EtO moving into and through the scrubber sheet, by diffusion, the air containing the EtO is pushed or pulled through using a conventional electric fan or other air moving device. The fan is preferably battery powered since most truck trailers do not have power available. For example, if a 500 mA fan is used, then a 30 AHr rechargeable battery will have a run time of about 60 hours. Alternatively for a truck trailer, it may be preferable to have a 12 V fan, powered by the truck, however, most trailers do not have power ports installed.

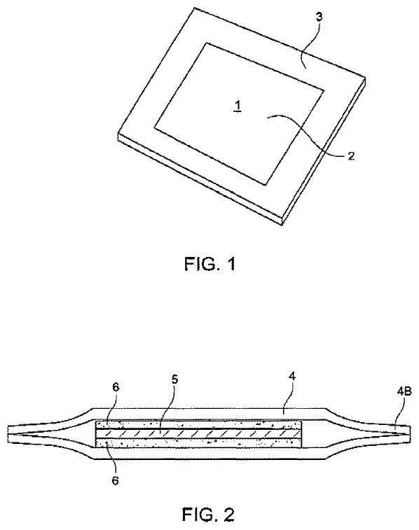

FIG. 1 shows the complete EtO scrubbing sheet 1. The center section 2 is the EtO scrubbing sheet, which can be used alone, but depending on the application may optionally be mounted in a frame 3. This frame can be made of cardboard, though other materials could also be used. The frame provides some rigidity that allows the EtO scrubbing sheet to be more easily placed between boxes or wherever needed. An alternative and preferred method for making the frame is to extend the outer protective layer without the acid or reagent layers (4 of FIG. 2) and join top and bottom edges together 4b (not shown) to form the frame, such that the joint not only seals the inner layers into the scrubber blanket but the seal also provides extra rigidity that allows the scrubber blanket to positioned and manipulated as discussed above. There are many conventional ways the seal can be made, including sewing, heat sealing, adhesive, crimping etc., though adhesion is the preferred method.

FIG. 2 shows a cross section through the EtO scrubbing sheet 1 without a separate frame 3 (of FIG. 1). The outer layer 4 is the protective gas-porous hydrophilic outer layer that allows access of the EtO gas and provides mechanical protection and water resistance to the inner layers and which is sealed at the edges 4b to form a frame. The inner layers consist of an acid layer comprising a solid acid on an inert support 5 covered on both sides by a reagent layer comprising an acid neutralizing reagent on an inert support 6. The EtO gas (not shown) will diffuse through the porous outer layer 4, through the neutralizing layer 6, to the acid layer 5, where the EtO reacts and is removed from the environment. If the EtO scrubbing sheet becomes wet, then the regent in the neutralizing layer 6 will dissolve and neutralize the acid in the acid layer 5.

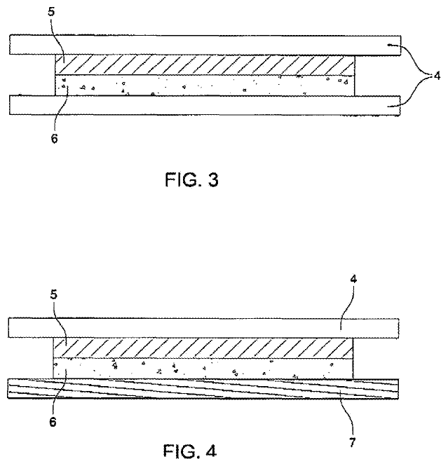

In some applications the EtO concentration is high and needs to be removed more quickly than is possible by relying on the EtO to diffuse through the neutralizing layer 6. FIG. 3 shows such an embodiment. As in FIG. 2, the outer layer 4 is the protective gas-porous hydrophilic outer layer that allows access of the EtO gas but provides mechanical protection and water resistance to the acid layer 6, which lies in contact with one of the outer layers 4. One the other side of the acid layer 6 lies the neutralizing layer 5. The EtO gas (not shown) will diffuse through the porous outer layer 4, to the acid layer 6, where the EtO reacts and is removed from the environment. If the EtO scrubbing sheet becomes wet, then the reagent in the neutralizing layer 6 will dissolve and neutralize the acid in the acid layer 5.

In some applications it is advantageous to have only one of the outer layers porous to EtO, the other outer layer should be non-porous. FIG. 4 shows an embodiment of the present invention with this configuration. As in FIG. 3, the top outer layer 4 is the protective gas-porous hydrophilic outer layer that allows access of the EtO gas but provides mechanical protection and water resistance to the acid layer 5, which lies directly below the outer layer 4. Below the acid layer 5 lies the acid neutralizing layer 6. The EtO gas (not shown) will diffuse through the porous outer layer 4, to the acid layer 5, where the EtO reacts and is removed from the environment. If the EtO scrubbing sheet becomes wet, then the reagent in the neutralizing layer 6 will dissolve and neutralize the acid in the acid layer 5. Below the neutralizing layer is a non-porous layer 7, which may be a polyethylene or polypropylene sheet, though it will be obvious to those with skill with material selection that many other materials may be used in light of this disclosure. The non-porous layer 7 provides mechanical and environmental protection of the acid layer 5, and neutralizing layer 6, and prevents any EtO which manages to pass through the acid layer 5 without reacting from escaping into the environment, and allows the EtO more time to react with the acid layer 5.

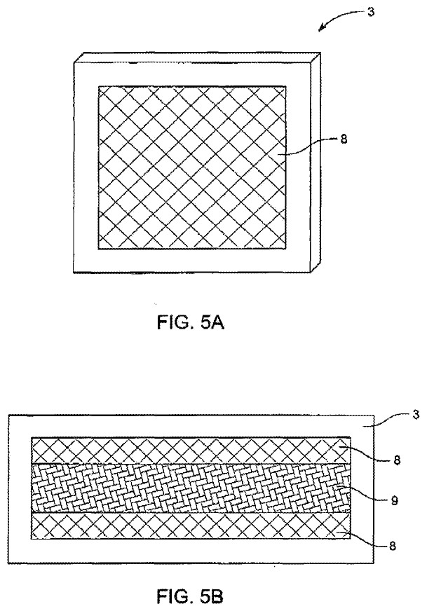

The scrubber sheet 1 is different if a fan (not shown) is being used to drive the air through the scrubber sheet 1. The porous outside membrane 4 used in the diffusion embodiments shown in FIGS. 1 through 4) impedes the forced air flow too much, and instead a reticulated membrane 8 is preferred. The support materials for the acid layer 9 and the neutralizer layer 10 in FIG. 5 should also be reticulated to improve the air flow. For purposes of this specification, reticulated means an open mesh, net or very open structure such that the air can flow through the material with minimum impediment. The preferred embodiment is to mount the scrubber sheet 1 into a frame 3, (e.g. plastic or cardboard), such that the operator can insert the scrubber sheet 1 in its frame into a slot in front of or behind the fan, such that the fan pushes or pulls the air through the scrubber, without the operator needing to touch the scrubber sheet 1. An alternative embodiment is to eliminate the outer protective membranes and instead have three reticulated layers, an acid layer 9 sandwiched between two neutralizing layers 8.

Because many varying and different embodiments may be made within the scope to the inventive concept herein taught, and because many modifications may be made in the embodiments herein detailed in accordance with the descriptive requirement of the law, it is to be understood that the details herein are to be interpreted as illustrative and not in a limiting sense.

1. An ethylene oxide (EtO) scrubbing sheet for the removal of EtO gas from ambient air, wherein the scrubbing sheet comprises at least one flexible gas porous protection layer and at least one gas porous support layer, wherein the gas porous support layer has been impregnated with a acid, wherein EtO gas in the ambient air passes into the scrubbing sheet by diffusion through the protection layer and undergoes an irreversible chemical reaction at the gas porous support layer to remove the EtO from the ambient air.

2. The EtO scrubbing sheet of claim 1, wherein the gas porous support layer is selected from the group consisting of non-woven or woven polyolefin, non-woven polypropylene, non-woven polyethylene, polyester, fiber glass, glass fiber paper, and silica impregnated polyethylene.

3. The EtO scrubbing sheet of claim 1, wherein the solid acid comprises a strong acid.

4. The EtO scrubbing sheet of claim 1, wherein the acid is selected from the group consisting of p-toluene sulfonic acid, naphthalene-2-sulfonic acid, and poly(styrene sulfonic acid).

5. The EtO scrubbing sheet of claim 1, where the gas porous support is substantially surrounded and in coplanar contact on both sides by a protection layer, said protection layer is comprised of a hydrophobic and gas porous membranous material.

6. The EtO scrubbing sheet of claim 1, wherein the EtO scrubbing sheet further comprises a first outer layer covering one side of the gas porous support layer and comprising a gas porous hydrophobic membrane and a second outer layer covering the other side of the gas porous support layer and comprising a gas impermeable and water impermeable membrane.

7. The EtO scrubbing sheet of claim 1, wherein the EtO scrubbing sheet further comprises at least one neutralizer layer covering at least one side of the gas porous support layer, wherein the at least one neutralizer layer comprises a sheet impregnated with an acid neutralizer.

8. The EtO scrubbing sheet of claim 7 where the acid neutralizer is selected from the group consisting of sodium citrate, sodium carbonate, sodium bicarbonate, and sodium borate.

9. A scrubbing sheet for the removal of EtO gas from ambient air, wherein the scrubbing sheet comprises an acid layer impregnated with acid, one or more neutralizer layers comprising a porous support impregnated with an acid neutralizer and located adjacent to the acid layer, wherein at least one of the one or more neutralizer layers is in planar contact with the acid layer, and a membrane layer comprising a gas porous hydrophobic membrane, adjacent to and in planar contact with at least one of the acid layers and the one or more acid neutralizer layers, whereby the EtO passes into the scrubbing sheet by diffusion through the membrane layer, whereupon the EtO undergoes an irreversible chemical reaction at the acid layer.

10. The EtO scrubbing sheet of claim 9, wherein the scrubbing sheet comprises at least two membrane layers, wherein one of the at least two membrane layers is adjacent to and in planar contact with the acid layer and wherein another of the at least two membrane layers is adjacent to and in planar contact with the one or more neutralizer layers.

11. The EtO scrubbing sheet of claim 9, wherein the membrane layer is located on and in planar contact with one side of the acid layer and one of the at least one neutralizer layers is located on and in planar contact with the opposite side of the acid layer.

12. The EtO scrubbing sheet of claim 9, wherein the support for the acid layer is selected from the group consisting of non-woven polyolefin, non-woven polypropylene, nonwoven polyethylene, fiber glass, glass fiber paper, and silica impregnated polyethylene.

13. The EtO scrubbing sheet of claim 9, wherein the acid is selected from the group consisting of p-toluene sulfonic acid, naphthalene-2-sulfonic acid, and poly(styrene sulfonic acid).

14. The EtO scrubbing sheet of claim 9, wherein the EtO scrubbing sheet comprises at least two membrane layers, each comprising a hydrophobic gas porous membrane, and at least one of the at least two membrane layers located on one side of the EtO scrubbing sheet and at least another of the at least two membrane layers is located on an opposite side of the EtO scrubbing sheet.

15. The EtO scrubbing sheet of claim 9, wherein the EtO scrubbing sheet further comprises a first outer layer covering one side of the gas porous support layer and comprising a gas porous hydrophobic membrane and a second outer layer covering the other side of the gas porous support layer and comprising a gas impermeable and water impermeable membrane.

16. The EtO scrubbing sheet of claim 9, wherein the EtO scrubbing sheet further comprises at least one neutralizer layer covering at least one side of the gas porous support layer, wherein the at least one neutralizer layer comprises a sheet impregnated with an acid neutralizer.

17. The EtO scrubbing sheet of claim 9 here the acid neutralizer is selected from the group consisting of sodium citrate, sodium carbonate, sodium bicarbonate, and sodium borate.

18. An ethylene oxide (EtO) scrubbing sheet for the removal of EtO gas from ambient air, wherein the scrubbing sheet comprises an acid layer comprising a reticulated support impregnated with an acid, a neutralizer layer comprising a reticulated support impregnated with an acid neutralizing chemical in planar contact with the acid layer, such that the EtO passes into the scrubbing sheet by active air flow by means of a fan, whereupon the EtO undergoes an irreversible chemical reaction at the acid layer.

19. The EtO scrubbing sheet of claim 18, wherein the EtO scrubbing sheet is packaged within a frame.

20. The EtO scrubbing sheet of claim 18, comprising at least one acid layer and at least one neutralizing layer in planar contact with at least one reticulated outer membrane.
